(19) United States
(12) Patent Application Publication
(10) Pub. No.: US 2008/0056461 A1
(43) Pub. Date: Mar. 6, 2008

(54) Method and apparatus for managing accounts of a web-phone

(75) Inventors: Yung-Lang Huang, Taipei City (TW); Yu-Cheng Tu, Taipei City (TW); Tsung-Yu Ma, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTek COMPUTER INC., Taipei City (TW)

(21) Appl. No.: 11/896,726

(22) Filed: Sep. 5, 2007

(30) Foreign Application Priority Data
Sep. 6, 2006 (TW) 095132905

(51) Int. Cl. H04M 11/00

(52) U.S. Cl. 379/88.17

(57) ABSTRACT

A method for managing accounts of a web-phone includes storing a user data, storing a login data for accessing a voice over Internet protocol (VoIP) system for performing web-phone communication, receiving a first data, comparing the first data and the user data, and accessing the VoIP system with the login data for immediately performing the web-phone communication when the first data conforms to the user data.

### BACKGROUND OF THE INVENTION

1. Field of the Invention

The present invention provides a method and apparatus for managing accounts of a web-phone, and more particularly, a method and apparatus using rememberable words or numbers or human characteristics as user data for accessing a voice over Internet protocol system.

2. Description of the Prior Art

With the highly developed and popular Internet, communication becomes more and more convenient. In the past, only through a public switched telephone network, or PSTN, could a real-time voice communication be realized, but now, the technology of voice over Internet protocol, or VoIP, makes real-time voice communication through the Internet possible. VoIP technology provides not only high-quality voice communication, but also exchanges of real-time images, data, etc. because the Internet has a larger bandwidth than the PSTN. Moreover, charges for Internet communication, especially for long-distance communication, are much cheaper than those for PSTN communication.

Therefore, communication through the Internet provides the service of high-quality voice and images exchanges with cheap charges. However, since a VoIP system is constructed under Internet protocol, there are no dedicated lines for web-phones. Therefore, a user must apply for a username and password for VoIP service of a VoIP system. When the user wants to use the VoIP service, the user must login the VoIP system with the username and password, which is much different from typical dialing. Besides, the user must keep the username and password firmly in mind, which is again inconvenient.

### SUMMARY OF THE INVENTION

It is therefore a primary objective of the claimed invention to provide a method and apparatus for managing accounts of a web-phone.

The present invention discloses a method for managing accounts of a web-phone. The method comprises storing a user data, storing a login data for accessing a voice over Internet protocol (VoIP) system for performing web-phone communication, receiving a first data, comparing the first data and the user data, and accessing the VoIP system with the login data for immediately performing the web-phone communication when the first data conforms to the user data.

The present invention further discloses a device for managing accounts of a web-phone. The device comprises a storage unit for storing a user data and a login data for accessing a voice over Internet protocol (VoIP) system, a data reception unit for receiving a first data, a comparison unit for comparing the first data and the user data, and a logic unit for accessing the VoIP system with the login data for immediately performing the web-phone communication when the first data conforms to the user data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a process for managing accounts of a web-phone in accordance with the embodiment of the present invention.

FIG. 2 illustrates a schematic diagram of a device for managing accounts of a web-phone in accordance with the embodiment of the present invention.

### DETAILED DESCRIPTION

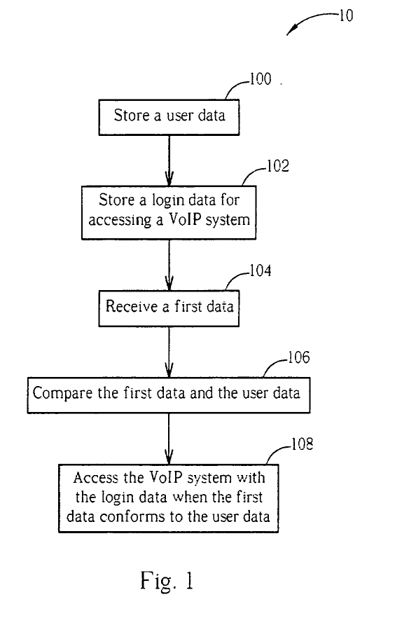

Please refer to FIG. 1, which illustrates a schematic diagram of a process 10 for managing accounts of a web-phone in accordance with the embodiment of the present invention. The process 10 includes following steps:

Step 100: store a user data.

Step 102: store a login data for accessing a VoIP system.

Step 104: receive a first data.

Step 106: compare the first data and the user data.

Step 108: access the VoIP system with the login data when the first data conforms to the user data.

Therefore, according to the process 10, a storage unit stores the user data and the login data first. The process receives the first data when a user wants to use the web-phone, and determines whether the first data conforms to the user data. If the first data conforms to the user data, the process 10 logs in the VoIP system with the login data. In other words, the user needs not remember the login data (i.e. a username and a password), but the user can set common-use or rememberable words or numbers, such as a mobile phone number, as the user data. Then, when using the web-phone, the user can input the user data, and the web-phone logs in the VoIP system with the login data. That is, the embodiment of the present invention can enhance convenience, and prevent problems caused when user forgets the username and the password.

Note that, the user data can be numbers or words set by the user. Certainly, other than the mobile phone number, the present invention can set human characteristic data, such as characteristics of fingerprints, voiceprints, palm prints, or irises of the user, as the user data. Take fingerprints for example, the web-phone stores a characteristic of the user's fingerprints as the user data, and when the user wants to use the web-phone for a phone call, the web-phone checks if the user's fingerprints conform to the user data with a fingerprint identification device. If the user's fingerprints conform to the user data, the web-phone logs in the VoIP system with the login data, which can include information of a username, password, IP address, communication port, etc.

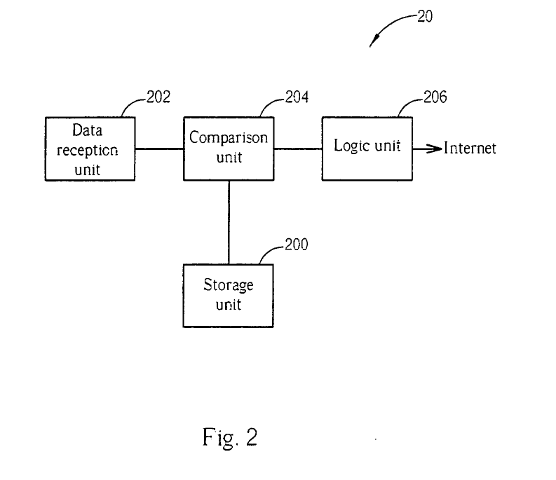

Please refer to FIG. 2, which illustrates a schematic diagram of a device 20 for managing accounts of a web-phone in accordance with the embodiment of the present invention. The device 20 includes a storage unit 200, a data reception unit 202, a comparison unit 204, and a logic unit 206. The storage unit 200 is utilized for storing the user data and the login data. The data reception unit 202 is utilized for receiving the first data. The comparison unit 204 is coupled to the storage unit 200 and the data reception unit 202 for comparing the first data and the user data. The logic unit 206 is coupled to the comparison unit 204 for accessing the VoIP system with the login data when the first data conforms to the user data.

Therefore, in the device 20, the storage unit 200 stores the user data and the login data first. When a user wants to use the web-phone, the data reception unit 202 receives the first data, and the comparison unit 204 determines whether the first data conforms to the user data. If the first data conforms to the user data, the logic unit 206 logs in the VoIP system with the login data stored in the storage unit 200. In other words, the user needs not remember the login data (i.e. a username and a password), but the user can set common-use or rememberable words or numbers, such as a mobile phone number, as the user data. Then, when using the web-phone, the user can input the user data, and the web-phone logs in the VoIP system with the login data. That is, the embodiment of the present invention can enhance convenience, and prevent problems caused when user forgets the username and the password.

Certainly, the user data can be human characteristic data, such as characteristics of fingerprints, voiceprints, palm prints, or irises of the user, and the data reception unit 202 is a corresponding identification device. Take fingerprints for example, the storage unit 200 stores a characteristic of the user's fingerprints as the user data, and when the user wants to use the web-phone for a phone call, the data reception unit 202 receives the user's fingerprints for the comparison unit 204 to check if the user's fingerprints conform to the user data. If the user's fingerprints conform to the user data, the logic unit 206 logs in the VoIP system with the login data, which can include information of a username, password, IP address, communication port, etc.

In summary, the embodiment of the present invention can set rememberable words or numbers or human characteristics as the user data, and the user needs not remember the username and password for accessing the VoIP system, so as to enhance convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing accounts of a web-phone comprising:
storing a user data;
storing a login data for accessing a voice over Internet protocol (VoIP) system for performing web-phone communication;
receiving a first data;
comparing the first data and the user data; and
accessing the VoIP system with the login data for performing the web-phone communication when the first data conforms to the user data.

2. The method of claim 1, wherein the user data is a phone number.

3. The method of claim 1, wherein the user data is a human characteristic data.

4. The method of claim 3, wherein the human characteristic data is corresponding to characteristics of fingerprints, voiceprints, palm prints, or irises of a user.

5. The method of claim 1, wherein the login data comprises a username and a password for accessing the VoIP system.

6. The method of claim 5, wherein the login data further comprises an Internet protocol address and a communication port for accessing the VoIP system.

7. A device for managing accounts of a web-phone comprising:
a storage unit for storing a user data and a login data for accessing a voice over Internet protocol (VoIP) system;
a data reception unit for receiving a first data;
a comparison unit coupled to the storage unit and the data reception unit for comparing the first data and the user data; and
a logic unit coupled to the comparison unit for accessing the VoIP system with the login data for performing the web-phone communication when the first data conforms to the user data.

8. The device of claim 7, wherein the user data is a phone number.

9. The device of claim 7, wherein the user data is a human characteristic data.

10. The device of claim 9, wherein the human characteristic data is corresponding to characteristics of fingerprints, voiceprints, palm prints, or irises of a user.

11. The device of claim 7, wherein the login data comprises a username and a password for accessing the VoIP system.

12. The device of claim 11, wherein the login data further comprises an Internet protocol address and a communication port for accessing the VoIP system.
